(19) United States
(12) Patent Application Publication
(10) Pub. No.: US 2023/0222446 A1
(43) Pub. Date: Jul. 13, 2023

(54) METHODS AND SYSTEMS FOR ONLINE SECURED TWO-PARTY COLLABORATIVE PREPARATION OF A FORMAL IP APPLICATION AND CONTROLLED ONLINE DELIVERY OF THE IP APPLICATION TO A SELECTED AGENCY

(71) Applicant: Gowling WLG International Limited, London (GB)

(72) Inventor: Houston Brown, Calgary (CA)

(73) Assignee: Gowling WLG International Limited, London (GB)

(21) Appl. No.: 17/996,975

(22) PCT Filed: Apr. 23, 2021
(86) PCT No.: PCT/IB2021/053386

§ 371 Date: Oct. 24, 2022

Related U.S. Application Data
(60) Provisional application No. 63/014,480, filed on Apr. 23, 2020.

(51) Int. Cl. G06Q 10/101; G06Q 50/18

(52) U.S. Cl. CPC G06Q 10/101; G06Q 50/184

(57) ABSTRACT

Disclosed are systems and methods for a first party to create, maintain, and operate an IP-xMOOC website for access to by second parties whereby a second party may register as a registered user of the first party's IP-xMOOC site, and may optionally be onboarded as a client by the first party. The onboarded client may access a restricted-access formal IP document template from the first party's IP-xMOOC site and then collaborate by encrypted electronic communication with a selected IP professional associated with the first party, prepare and finalize a formal IP document, that the IP professional may file electronically with a selected government agency.

### CROSS-REFERENCE TO RELATED APPLICATIONS

This application claims the benefit of U.S. Provisional Patent Application Ser. No. 63/014,480, filed Apr. 23, 2020, the content of which is incorporated herein by reference in its entirety.

### TECHNICAL FIELD

This disclosure generally relates to online learning methods and systems. More specifically, this disclosure pertains to methods and systems for online learning-based collaborative client and service provider development of formal intellectual property documents using progressive gated decision steps, and for controlled secured filing of a collaboratively produced document with a selected agency.

### BACKGROUND

Online learning programs have been available since the advent of the internet era which made it possible for educators to post various types of education materials and resources onto their websites for remote access by third parties using their office-based or home-based computer equipment, and other electronic devices such as for example, WI-Flo-enabled laptops, tablets, smartphones, and the like (WI-FI is a registered trademark of Wi-Fi Alliance, Austin, Tex., USA).

Online learning programs now available make it possible for educational institutions to register students for remote online access to multiple courses in selected programs that controllably provide a registered student with access to course materials, related resources, and to instructors. Such online learning programs may provide registered students with formal exams that are completed and submitted to the institution online, then marked and/or assessed and/or graded either electronically or by an instructor, and then returned to a registered student. Such interactions between a registered student, an institution providing an online course, and an instructor responsible for preparing and providing the online course are protected by online security programs that require the use of registrations and password protection. Some online courses provide chat features such as a restricted access private chat between a registered student and an instructor, and a restricted access group chat between an instructor and a group of students registered for a selected online course.

During the past decade, there has been a proliferation of “massive online open courses” commonly referred to as massive open online courses (MOOCs), emerging from numerous post-secondary universities, colleges, and technical institutes. The aim of MOOCs is to provide online courses with unlimited participation and access via the internet to organized traditional course content such as lecture videos, podcasts, downloadable problem sets and in some MOOCs, access to and participation in user forums or social media discussions between students, teachers, and teaching assistants. While some MOOCs have no restrictions to access to their course materials and participants in the courses, other MOOCs have developed gated access whereby one or more subgroups of the online course content and materials are available freely to anyone entering their websites, while access to other subgroups of the online course content materials are restricted to users who go through a registration process requiring disclosure of their information and payment of a fee. Such types of access are commonly referred to as “free access” and “premium access”, and such types of MOOCs are commonly referred to as “xMOOCs”.

During recent years, the rapid pace of technology development, commercialization, and monetization has led to the development of MOOCs pertaining to intellectual property (IP), and focused on providing open online content and resources to inventors, entrepreneurs, and innovators working in industries or institution. Examples of such IP-focused MOOCs can be found by browsing the “My MOOC” site (link below), the “Coursera” site (link below), and the Centre for International Governance Innovation site (link below), among others:

https://www.my-mooc.com/en/mooc/intellectual-property-law-policy-part-1-pennx-iplaw1x/
https://www.coursera.org/courses?query=intellectual %20property
https://mooc.cigionline.org/course/view.php?id=6&section=0

Consumers of such IP-focused MOOCs learn that there are generally five types of IP that are available for protection of new innovations: (i) trade secrets, (ii) patents, (iii) industrial designs, (iv) trademarks, and (v) copyrights. Trade secrets and copyrights arising from new innovations can be maintained by following the information provided in IP-focused MOOCs. However, the problems for an innovator pertain to the steps they need to take to prepare and file a patent application and/or an industrial design registration application (also referred to as a design patent application) and/or for an application for a trademark registration.

Patent applications and industrial design registration applications must be filed with a Patent Office in a selected jurisdiction, by an inventor or by an applicant to whom the inventor has assigned their rights or by a representative to whom the inventor and/or the applicant have given their power-of-attorney. The format and content of patent applications and industrial design registrations are set out in each jurisdiction's Patent Act and Patent Rules. Successful prosecution of a patent application through to a Notice of Allowance from a Patent Office, often requires the exchange of two or three or more Office Actions and responses between a Patent Examiner and the correspondent responsible for the application (i.e., the inventor or their assignee or a registered patent agent/attorney to whom they have given their power-of-attorney) over an extended period of time that may range from 1-5 years. Successful procurement of a Notice of Allowance requires confirmation and agreement by the Patent Examiner and the correspondent that the allowed claims are: (i) novel, (ii) not obvious to someone skilled in the art, (iii) have commercial value, and (iv) are enabled in the description of the invention. Due to the complexity and the legal constraints on the format and content of an enabled patent application and on the patent prosecution process, most inventors and innovators decide that their preferred route to secure IP protection is retain a registered patent agent/attorney.

The problem with IP-focused MOOCs is that while their content and resource materials may provide information for an inventor/innovator on how to prepare and file a patent application or an industrial design registration application or a trademark information, after an inventor/innovator determines it is in their best interests to retain a qualified patent agent or trademark agent to work with on the preparation, filing, and prosecution of their application, the inventor/innovator must then proceed on their own to source, identify, and retain a qualified professional who possesses the requisite technical expertise, the IP expertise and experience to provide the services.

### SUMMARY

The embodiments of the present disclosure generally relate to methods and systems for online secured collaborative preparation of a formal intellectual property (IP) application by a first party and a second party, and for controlled secured filing by the first party, of the formal IP application with a selected Government Intellectual Property Protection Agency.

Some embodiments of the present disclosure relate to a massive open online course (MOOC) system for providing information, content, resource materials, and work-product templates pertaining to intellectual property (IP) wherein the course system comprises: (i) one or more subgroups of freely available and unrestricted course content and materials, (ii) one or more subgroups of restricted course content whereto access is provided through at least one or more approval/rejection gateways. These massive open online course systems for providing unrestricted and restricted access to information, content, resource materials, and work-product templates pertaining to intellectual property, are also referred to herein as IP-xMOOC sites.

According to an aspect, the first party is an IP service provider who creates, compiles, provides, communicates, operates, maintains, and updates the unrestricted-access and the restricted-access information, content, resource materials, and work-product templates on an IP-xMOOC site, that is accessible by second parties.

According to an aspect, a second party is an individual who visits a first party's IP-xMOOC website and accesses the information, content, and resource materials in the IP-xMOOC site for the purposes of learning about intellectual property and intellectual property rights, processes for securing protection for intellectual property rights, and securing intellectual property rights. The second party individual may be an inventor or an innovator working independently and may be visiting the IP-xMOOC site for their personal interests.

Some embodiments of the present disclosure relate to a computer system for online secured two-party collaborative preparation of a formal application document and controlled online delivery of the document to a selected agency, the system comprising:
a memory;
one or more cloud-based databases;
a network or a communication connection; and
a processing structure coupled to the memory, the one or more cloud-based databases, and the network or the communication connection;
wherein the processing structure, the memory, the one or more cloud-based databases, and the network or the communication connection form a single computerized platform; and
wherein the processing structure is configured for creation by a first party of an IP-xMOOC web for controllable access by a second party, for registering the second party as a registered user, and for onboarding the second party as a client.

Some embodiments of the present disclosure relate to a computer-implemented method for online secured two-party collaborative preparation of a formal application document and controlled online delivery of the document to a selected Government Intellectual Property Protection Agency, the method comprising:
providing, by a first party, controllable access to an IP-xMOOC web site and a related IP-xMOOC system;
providing a second party access to the first party's IP-xMOOC web site for progressively registering as a registered user and engaging with a client-onboarding gate within the IP-xMOOC web site by receiving from the second party information and data requested by the client-onboarding gate and by allowing the second party to review second party's information and data, and agree to accept the second party as an onboarded client, for providing encrypted electronic IP professional services to the second party as a client;
receiving from the second party as the onboarded client a selection of an IP document template, receiving from the second party as the onboarded client data and information and entering received data and information into the selected IP document template thereby producing a partially completed IP document, and electronically sending the partially completed IP document to a selected IP professional associated with the first party;
electronically exchanging the partially completed IP document between the IP professional and the client for one or more times until the IP document is completed; and
electronically filing, by the IP professional, the completed IP document with a selected Government Intellectual Property Protection Agency.

### BRIEF DESCRIPTION OF THE FIGURES

The embodiments of the present disclosure will be described with reference to the following drawings in which:

FIG. 1 is a schematic illustration, according to some embodiments of the present disclosure, of a four-level hierarchical organization of individual content items into a first party's IP-xMOOC site wherein a second party's access to some of the individual content items is restricted by one or two or three access gates;

FIG. 2 is a schematic illustration, according to some embodiments of the present disclosure, of an example of a three-component digital business development (BD) funnel that may be overlaid onto and interactive with the individual content items uploaded into a first party's hierarchical-ordered IP-xMOOC site;

FIG. 3 is a schematic illustration of a top-level component of the digital BD funnel shown in FIG. 2;

FIG. 4 is a schematic illustration of a mid-level component of the digital BD funnel shown in FIG. 2;

FIG. 5 is a schematic illustration of a bottom-level component of the digital BD funnel shown in FIG. 2.

FIG. 6 is a schematic diagram of a system for online secured two-party collaborative preparation of a formal IP application and controlled online delivery of the application to a selected agency, according to some embodiments of the present disclosure;

FIG. 7 shows the hardware structure of a computing device of system shown in FIG. 6; and

FIG. 8 shows a simplified software architecture of a computing device of the system shown in FIG. 6.

### DETAILED DESCRIPTION

The embodiments of the present disclosure generally relate to methods and systems for online secured collaborative preparation of a formal intellectual property (IP) protection application by a first party and a second party, and for controlled secured filing by the first party, of the formal IP protection application with a selected Government Intellectual Property Protection Agency.

An embodiment of the present disclosure relates to a massive open online course (MOOC) system for providing information, content, resource materials, and work-product templates pertaining to intellectual property (IP) wherein the course system comprises: (i) one or more subgroups of freely available and unrestricted course content and materials, (ii) one or more subgroups of restricted course content whereto access is provided through at least one or more approval/rejection gates. This MOOC system for providing unrestricted and restricted access to information, content, resource materials, and work-product templates pertaining to intellectual property, is also referred to herein as an IP-xMOOC site.

According to an aspect, the first party is an IP service provider who creates, compiles, provides, communicates, operates, maintains, and updates the unrestricted-access and the restricted-access information, content, resource materials, and work-product templates available on the IP service provider's IP-xMOOC site. The IP service provider may be a firm comprising one or more registered patent agents/attorneys. The IP service provider may be a firm comprising one or more registered trademark agents/attorneys. The IP service provider may be a firm comprising one or more registered patent agents/attorneys and one or more registered trademark agents/attorneys. The IP service provider's registered patent agents/attorneys and/or registered trademark attorneys are also referred to herein as “IP professionals”.

According to an aspect, the second party is an individual who visits the first party's IP-xMOOC website and accesses the information, content, and resource materials in the IP-xMOOC site for the purposes of learning about intellectual property and intellectual property rights, processes for securing protection for intellectual property rights, and securing intellectual property rights. The second party individual may be an inventor or an innovator working independently and may be visiting the IP-xMOOC site for their personal interests. Alternatively, the second party individual may be an employee of a commercial company with responsibilities that may include managing innovation development, procurement, and/or protection. Alternatively, the second party individual may be a member of another IP service provider firm.

Another embodiment generally relates to a hierarchal organization of the information, content, resource materials, and work product templates flowing out of an IP topic tab listed on an example of a first party's IP-xMOOC site according to the present disclosure. Examples of suitable IP topic tabs may include (i) what is IP, (ii) patents, (iii) industrial designs/design patents, (iv) trademarks, (v) copyrights, (vi) trade secrets, (vii) branding, (viii) IP portfolios, (ix) IP strategies, (x) commercialization, (xi) IP monetization, (xii) IP enforcement, (xiii) lists of professionals, and the like. Individual content items accessible within the topic tabs may comprise a format that is a (i) viewable-only content item, (ii) a non-interactive downloadable content item, (iii) an interactive downloadable fillable content item, (iv) one or more downloadable fillable template items, (v) links to selected webpages on the first party's website, (vi) links to selected webpages from a selected Government Intellectual Property Protection Agency's website, among other types of formats.

Viewable-only content formats may include recorded video contents, recorded audio contents, Microsoft® PowerPoint® presentations (MICROSOFT and POWERPOINT are registered trademarks of Microsoft Corp., Redmond, Wash., USA), written materials in the forms of scrollable web pages, uploaded articles in pdf format, and other such content formats. Examples of recorded video contents include videocasts, “snapshot” videos, videos of panel discussions and/or interviews, webinars, and the like. Examples of recorded audio contents include podcasts, voice-over PowerPoint presentations, and the like.

As used herein, the term “videocast” refers to a recorded video presentation pertaining to a specific IP topic wherein the presenter is an IP professional associated with the first party. A videocast may be of any length between 1 to 30 minutes.

As used herein, the term “IP professional” means a registered patent agent or attorney and/or a registered trademark agent or attorney associated with the first party.

As used herein, the term “snapshot video” as used herein refers to a short videocast having a 1 to 4-minute duration.

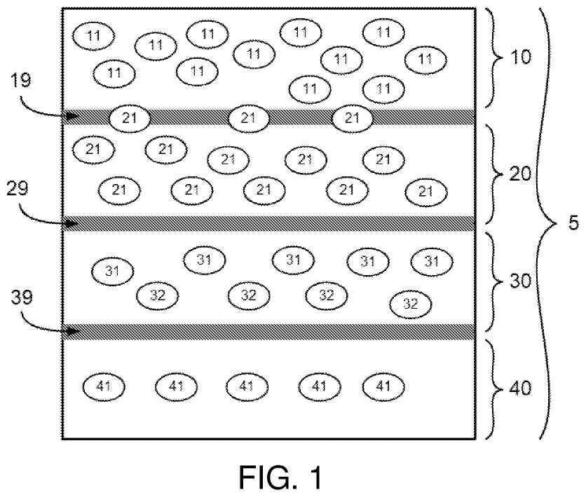

Another embodiment disclosed herein is illustrated in FIG. 1 and relates to separation of a hierarchal organization 5 of the first party's information, content, resource materials, and work product templates made available on their IP-xMOOC site, into four layers 10, 20, 30, 40 having computer-implemented restricted-access gates 19, 29, 39 between layers 10-20, 20-30, and 30-40 respectively. The top-level layer (Level 1) 10 may comprise uploaded individual content items 11 that are freely accessible and viewable by any second party that visits the first party's IP-xMOOC site.

The second-level layer (Level 2) 20 may comprise individual content items 21 that are viewable under a first computer-implemented restricted-access gate 19. A second party may access and view the individual content items in Level 2 by completing and filing a first registration form that is associated with the first computer-implemented restricted-access gate 19. Examples of registration information required for a second party to fill in on the first registration form may include: (i) a username, (ii) the second party's email address, and optionally one or more of the second party's (iii) IP interest(s), (iv) vocation, (v) employer category, (vi) employment position/category. Completion and submission of the registration information required at the first computer-implemented restricted-access gate 19 may result in the second party being given a “registered user” designation and identification.

The third-level layer (Level 3) may comprise individual content items 31 that are accessible and viewable by a registered user through a second computer-implemented restricted-access gate 29, also referred to herein as a “paywall”, wherein each individual content item 31 may be accessed by an online payment from a registered user to the first party. After payment for access to a selected content item 31 is received from a registered user by the first party, the registered user may receive unrestricted access to the paid-for selected content item 31 for as long as the first party maintains the paid-for selected content item 31 on their IP-xMOOC site. For some selected content items 31, continued access may be provided to the registered user on a subscription basis for example, by payment of an annual subscription fee. For other selected content items 31, paid-for access may be provided to the registered user on a one-time-only basis. A registered user who have provided payments for access through the paywall 29, is referred to herein as “an enhanced registered user”.

The fourth-level layer (Level 4) may comprise individual content items 41 that are accessible and viewable by a registered user through a third computer-implemented restricted-access gate 39. Submission of a request by a registered user at the third computer-implemented restricted-access gate 39 for access to a selected content item 41 may include a requirement for a concurrent request for professional engagement of the first party for assistance with and interaction with one or more content items 41. A registered user's concurrent submission of a request for access to a selected content item 41 and request for professional engagement of the first party will initiate a series of computer-implemented client-onboarding steps at the third restricted-access gate 39. For example, a first step may be a request for the registered user to provide: (i) their business and contact information, (ii) identification of the selected content item 41, (iii) the intended purpose and use of the selected content item 41, and optionally (iv) a background technical and/or summary of the registered user's information to be input in to the selected content item 41, and optionally (v) a request for engagement with a selected IP professional. The next step may be for the first party to have an internal conflict search and assessment done in reference to the information provided by the registered user in response to the information requested at the third restricted-access gate 39. The internal conflict search and assessment process may be a computer-implemented process incorporated to the first party's IP-xMOOC system and/or a process performed separately by the first party and the subsequent accept/decline decision uploaded into first party's IP-xMOOC system. The first party's conflict search and assessment may check all of their existing and previous clients, matters, contacts, vendors and related information to determine if the first party could potentially have a conflict of interest in accepting the registered user's request for a professional engagement in regard to their selected content item 41.

If the conflict check and assessment identify a potential conflict of interest for the first party, the next step will be for the third computer-implemented restricted-access gate 39 to decline the registered user's request for professional engagement and will deny access to the selected content item 41.

If the conflict check and assessment do not identify any potential conflicts of interest for the first party, the next steps will be for the third computer-implemented restricted-access gate 39 to: (i) provide a downloadable retainer letter in reference to the information provided by the registered user during the first step, (ii) request that the registered user executes, for example by digital signature, and returns the executed retainer letter using means provided therefor in the third restricted-access gate 39, and (iii) provide a retainer fee electronically using means provided therefor in the third restricted-access gate 39.

After the executed retainer letter and the retainer fee are returned using means provided therefor in the third computer-implemented restricted-access gate 39, the client-onboarding process may have been completed and the registered user is then considered a client.

If the onboarded client requests engagement with a selected IP professional during the first client-onboarding step, then the third computer-implemented restricted-access gate 39 will provide the client with access to the selected contact item 41 and will send an electronic notification to the selected IP professional that access to the selected contact item 41 was provided to the client.

If the onboarded client did not request engagement with a selected IP professional during the first client-onboarding step, then the third computer-implemented restricted-access gate 39 may provide the client with a list of the first party's IP professionals for the client's review and selection of an IP professional. After the client selects an IP professional, the third computer-implemented restricted-access gate 39 will then provide the client with access to the selected contact item 41 and will send an electronic notification to the selected IP professional notifying the IP professional that access to the selected contact item 41 was provided to the client.

Example embodiments of freely accessible and viewable individual content items 11 may be any of video contents, recorded audio contents, “thought-leadership” written materials in the forms of scrollable web pages, and other such content formats, and may specifically relate to one or more of patents, trademarks, copyrights, industrial designs, and trade secrets.

Example embodiments of individual content items 21 may be any of video contents, recorded audio contents, webinars, PowerPoint presentations, written materials in the forms of scrollable web pages, uploaded articles in pdf format, posted links to the first party's other webpages, posted links to Government agency webpages, and other such content formats, and may specifically relate to one or more of patents, trademarks, copyrights, industrial designs, and trade secrets.

According to an embodiment, an individual content item 21 may be a course module comprising a series of lessons wherein each lesson may include one or more of a video presentation, a voice-over PowerPoint® presentation, links to selected webpages on the first party's IP-xMOOC site, links to selected webpages on the first party's web site, downloadable resource materials, interactive fillable forms and/or checklists, and the like.

An example of an individual content item 21 in the form of a course module may have a title such as “IP Portfolio Checkup”. In this example, the “IP Portfolio Checkup” course module may comprise nine lessons titled:
21.1.1: Creating a comprehensive IP strategy.
21.1.2: Offensive and defensive aspects of a patent strategy.
21.1.3: Aligning IP and Business Strategies.
21.1.4: IP portfolio reviews and audits.
21.1.5: Integration of IP reviews into patent portfolio management practices.
21.1.6: Business-focused invention discovery and development policies.
21.1.7: Business-focused IP assessment and valuation for earlier-stage companies.
21.1.8: Differences between patent laws, regulations, and practice in Canada, the USA, and Europe.
21.1.9: Forecasting, budgeting, and managing IP portfolio costs.

In this example, some of the lessons may be presented in a video format with one presenter delivering the lesson content in reference to one or more lesson props. Some of the lessons may be presented in a video formation with two presenters engaged with the each other and the viewing audience, in reference to one or more lesson props. Some of the lessons may be presented in a voice-over PowerPoint® format. This example of an “IP Portfolio Checkup” course module may additionally comprise a plurality of downloadable resource or reference materials with titles such as:
21.1.10: “Landscaping: knowing your competitive context”.
21.1.11: “Mining patent databases”.
21.1.12: “Using contracts to support IP strategy”.
21.1.13: “Capitalizing on your IP asset licensing”.
21.1.14: “Strategic pacing during patent prosecution”.
21.1.19: “Prophetic patent drafting: getting the most out of your innovations”,

and the like.

Another example of an individual content course-module item 21 may have a title such as “Branding Basics”. In this example, the “Branding Basics” course module may comprise seven lessons titled:
21.20.1: How to choose a strong brand (what makes a strong trademark).
21.20.2: Making sure your brand is available (clearing your trademark).
21.20.3: Why and where do you want to protect your rights (trademark registration).
21.20.4: Best practices in using your brand.
21.20.5: Protecting the other ways that people see, hear and smell your brand (non-traditional marks).
21.20.6: Using your brand on the internet (domain names, ecommerce, social media, and the like).
21.20.7: Top 10 differences between protecting your brand in Canada and in the USA.

Example embodiments of individual content items 31 may be a plurality of IP-focused educational course items wherein each course may have a curriculum 32 containing a selected listing of lessons for example, 2 or 3 or 4 or 5 or 6 or 7 or 8 or 9 or 10 or 11 or 12 or more lessons. Each of the lessons within a course may comprise one or more of a video presentation, a voice-over PowerPoint® presentation, reference materials, interactive fillable question/answer study materials, interactive fillable checklists, and the like. According to an aspect, the fillable materials may be interactive online only during a single session and may not be downloadable. According to another aspect, the fillable materials may be interactive online only during a single session and may be downloaded at the end of a single session. According to another aspect, the fillable materials may be interacted with during a session, then saved for recovery and further interaction with during another session.

According to an embodiment, the listing of lessons in a course curriculum 32 may be viewed by a registered user. However, the second restricted-access gate 29 may restrict a registered user's access to the lesson contents within a selected course curriculum 32, unless the registered user provides an online payment of a specified fee for access to the course contents. After payment for access to a selected content item 31 is received from a registered user by the first party, the registered user may receive unrestricted access to the paid-for selected content item 31 for as long as the first party maintains the paid-for selected content item 31 on their IP-xMOOC site. For some selected content items 31, continued access may be provided to the registered user on a subscription basis for example, by payment of an annual subscription fee.

An example of a course curriculum 32 may have a title such as “Patenting Streamliner”. In this example, the “Patenting Streamline” curriculum may comprise nine lessons titled:
31.1.1: Preparing to Patent Overview.
31.1.2: Identifying your business objectives.
31.1.3: Analyzing what is already out there.
31.1.4: Framing problems and solutions.
31.1.5: Articulating your breakthrough.
31.1.6: Enabling and supporting your claims.
31.1.7: How to Support Descriptive Text with Drawings.
31.1.8: Forecasting further technical developments for your invention.
31.1.9: Who is and who isn't an inventor.
31.1.10: Who owns the rights to a patent application and options for transferring those rights.

In this example, some of the lessons may be presented in a video format with one presenter delivering the lesson content in reference to one or more lesson props. Some of the lessons may be presented in in a video formation with two presenters engaged with the each other and the viewing audience, in reference to one or more lesson props. Some of the lessons may be presented in a voice-over PowerPoint® format. This example of a “Patenting Streamliner” course module may additionally comprise a plurality of downloadable resource or reference materials with titles such as:
31.1.11: “Should you patent it?”.
31.1.12: “Patent before you publish!”.
31.1.13: “Turning your SRED claim into a patent application”.
31.1.14: “Inventorship: practical insights on how to deal with a complicated issue”.
31.1.19: “Good management practices for maintaining written documents and electronic files relating to research, development, and scaling of innovation, to enable identification of potentially patentable inventions”,
31.1.16 “Government agency support programs for protecting patentable inventions”, and the like.

Another example of a course curriculum 32 may have a title such as “Branding Essentials”. In this example, the “Branding Essentials” course module may comprise seven lessons titled:
31.20.1: Trademark portfolio management and audits (scope of protection, defensive filing, international strategies).
31.20.2: “Use it or lose it” (avoiding cancellation of your registered trademark).
31.20.3: Brands going generic (managing your registered trademarks).
31.20.4: Brands on social media (managing your registered trademarks on social media platforms.
31.20.5: French language issues associated with registering trademarks.
31.20.6: Licensing, buying, and selling your brands/registered trademarks.
31.20.7: Top 10 differences between protecting your brand in Canada and in the USA.
31.20.8: Ensuring others are not undermining or leveraging your investment in your brand/registered trademark (watch program and oppositions).

Examples of content items 41 may be a plurality of IP-related one-party interactive computer-implemented work product templates and two-party interactive computer-implemented IP work product templates. Examples of one-party computer-implemented work product templates include Invention Disclosure Forms, patent database searching keywords, keyword combinations, and strategy listings, listings of potentially relevant publicly available patent documents and links thereto in selected patent databases, patent search reports, patentability assessments, trademark database searching keywords, keyword combinations, and strategy listings, listings of potentially relevant pending and registered trademarks and links thereto in selected patent databases, trademark search reports, and the like. Examples of two-party computer-implemented IP work product templates for computer-implemented collaborative input and revisions by the onboarded client and the first party's IP professional, include patent application templates, trademark application templates, industrial design registration templates, and the like. Alternatively, the first party may incorporate software for creation of such templates using software such as GHOSTDRAFT® products and the like (GHOSTDRAFT is a registered trademark of Korbicom PTY Ltd., Rondebosch, South Africa).

According to an embodiment of the present disclosure, a second party visiting the first party's IP-xMOOC site having multiple individual content items uploaded into a computer-implemented multi-level gated hierarchy, for example as illustrated in FIG. 1 and described above, may be able to quickly find content items of interest by entering a keyword into a computer-implemented search box provided therefor on the first party's IP-xMOOC home web page. The computer-implemented search results may be displayed, for example, as a listing of individual content item titles. The search results may be displayed within a computer-implemented topic tab assigned thereto.

According to an aspect, an unregistered second party may be able to see in response to a computer-implemented search term request, a listing of the individual content item 11 titles in an unrestricted access Level 1 (FIG. 1), a listing of the individual content item 21 titles in a first-gated restricted access Level 2 (FIG. 1), and a listing of the individual content item 31 titles in a second-gated restricted access Level 3 (FIG. 1). However, an unregistered second party would only be able to access and view individual content items 11 from the unrestricted access Level 1, but would not be able to open and view restricted-access individual content items 21, 31, and 41. The first party may make it optional for one or more selected first gate 19 restricted-access individual content items 21 available for access and viewing by an unregistered second part in response to an entry of one or more selected keyword search term pre-approved by the first party. Listings of restricted-access individual content item 41 titles available for access and viewing only by the first party's clients, would not appear in listings in response to computer-implemented keyword searching of the first party's IP-xMOOC site by an unregistered second party.

According to another aspect, a registered second party, i.e., a registered user, may be able see in response to an entry of one or more selected keyword search term pre-approved by the first party, a listing of the individual content item 11 titles in an unrestricted access Level 1 (FIG. 1), a listing of the individual content item 21 titles in a first-gated restricted access Level 2 (FIG. 1), a listing of the individual content item 31 titles in a second-gated restricted access Level 3 (FIG. 1), and a listing of the individual content item 41 titles in a third-gated restricted access Level 3 (FIG. 1). However, a registered user would only be able to access and view individual content items 11, 21 from Levels 1, 2 but would not be able to open and view restricted-access individual content items 31 and 41.

According to another aspect, a registered user may be able to see in response to a computer-implemented search term request, a listing of the individual content item 11 titles in an unrestricted access Level 1 (FIG. 1), a listing of the individual content item 21 titles in a first-gated restricted access Level 2 (FIG. 1), and a listing of the individual content item 31 titles in a second-gated restricted access Level 3 (FIG. 1) that they paid a fee for access to. However, a registered user would not be able to open and view unpaid content of the restricted-access individual content items 31 and 41.

According to another aspect, client may be able to see in response to a computer-implemented search term request, a listing of all individual content items 11, 21, 31, 41 in Levels 1, 2, 3, 4, and then access and view therefrom a selected individual content item.

Other embodiments disclosed herein relate to computer-implemented direction of topic tabs into “digital BD funnels” generated by a first party's IP-xMOOC system disclosed herein for online secured two-party collaborative preparation of a formal IP application and controlled online delivery of the application to a selected agency.

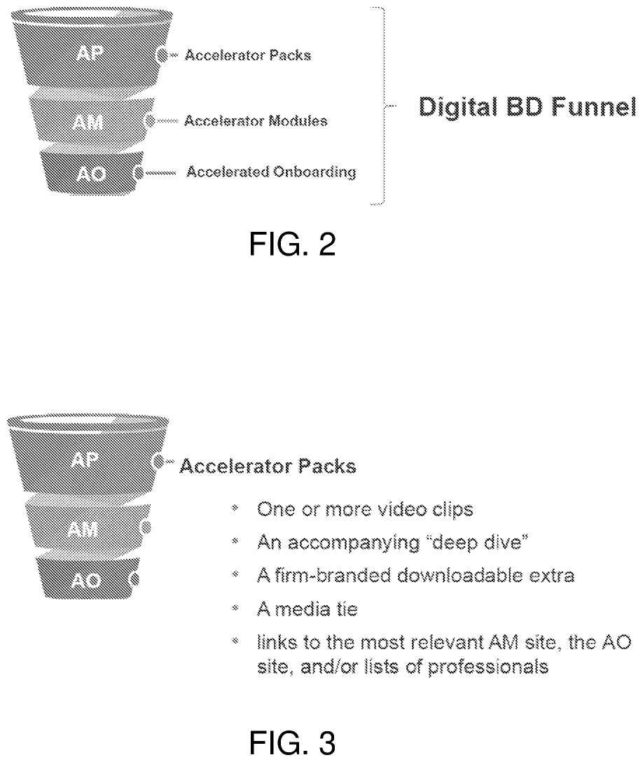

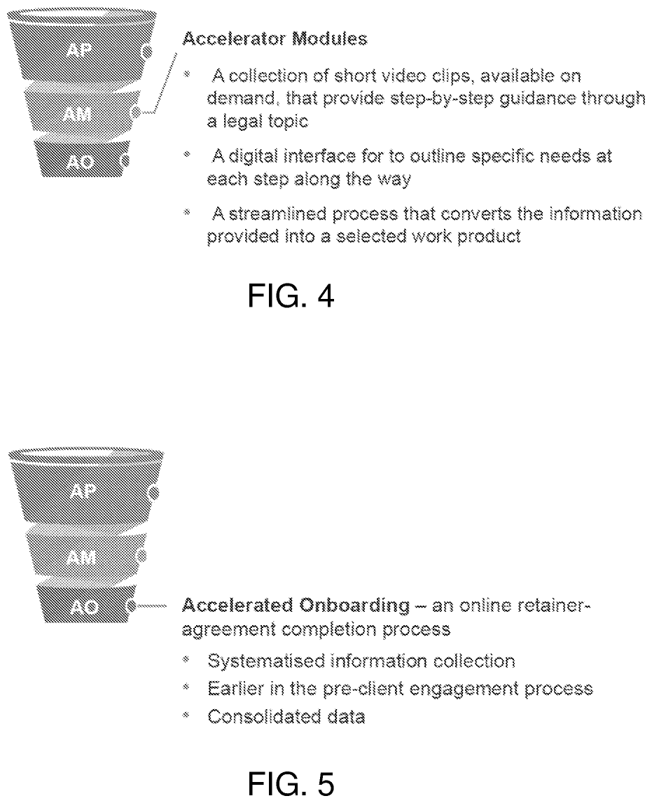

An example of a digital BD funnel associated with one or more topic tabs is shown in FIG. 2 and may generally comprise: (i) an “accelerator pack” comprising mixtures of information, content, resource materials, templates, and links to other selected landing pages (FIG. 3), (ii) an “accelerator module” comprising, for example, click-on picture links to short video clips, podcasts, one or more digital interfaces for information input or checklist inputs, resulting in a downloadable or printable work product (FIG. 4), and (iii) a gated “accelerated onboarding” module (FIG. 5) wherein a second party that visits the IP-xMOOC site for the first time, selects a topic tab, and then progressively drills down into and through the individual content items linked to the selected or searched-for topic tab, upon reaching a computer-implemented restricted-access gate (for example restricted-access gate 19 in FIG. 1), must provide information and agree to become a registered user in order to access restricted-access individual content items further within the selected topic tab.

According to an aspect, a digital BD funnel may be generated by an IP-xMOOC system disclosed herein, in response to one or more keyword searches conducted on the IP-xMOOC site by a second party visitor to the first party's IP-xMOOC site. A purpose for generating a digital BD funnel is to provide listings of individual IP content items 11, 21, 31, and optionally 41, that may engage and retain the second party's interest in the topic tabs that were displayed in response to their search terms, by providing free access to easily digestible IP-related news and information materials to thereby lead the second party to further explore and interact with IP teaching materials. Upon completion of interaction with one or more IP teaching materials provided to the second party via the digital business funnel, the second party may then be presented with an accelerated computer-implemented onboarding gateway whereby the second party may engage with and retain the first party for access to the first party's professional services.

An example of a professional service resulting from a second party successfully onboarded as a client by the first party via the digital BD funnel, may be use by the onboarded client of a patent application template accessible at the bottom of the digital BD funnel to initiate interactive secured and encrypted online two-party preparation with a first party's IP professional, of a formal patent application for filing with a selected Patent Office, after which, the first party's IP professional may electronically file the formal patent application with the selected Patent Office.

If the second party chooses not to provide information and/or does not agree to become a registered user, they will be blocked from proceeding further within their selected topic tab to view restricted-access individual content items. It is optional for the computer-implemented IP-xMOOC system to allow the second party to return to the IP-xMOOC home web page and browse into and through one or more other topic tab digital BD funnels until they reach another computer-implemented restricted-access gate wherein they are required to provide information for the next selected topic tab(s). It is within the scope of the present disclosure for the systems disclosed herein to record in a database provided therefor, the IP address of a second party's electronic device used to access the IP-xMOOC home web page. It is also within the scope of the present disclosure for the systems disclosed herein to block access to a second party who has accessed the IP-xMOOC home web page and drilled down through two or more selected topic tabs to the “accelerated onboarding” module and then chosen not to provide information to agree to become a registered user after the second party has accessed such content more than a number selected from “n+1” times, wherein “n” is a selected number.

According to another embodiment of the present disclosure, a first party's computer-implemented IP-xMOOC system may be configured to record and store in a database provided therefor, an internet protocol address (also referred to herein as an “IP address”) assigned to a device with which a second party uses to access the first party's IP-xMOOC home web page. The first party's IP-xMOOC system may be further configured to reference an IP address of any second user's device used to access the first party's IP-xMOOC home web page, with IP addresses previously recorded and stored in the IP-xMOOC IP addresses database, and to determine if the second party's IP address is associated with a registered user and/or a paid registered user and/or an onboarded client, and to further determine and record, how many times a second party's IP address has accessed first party's IP-xMOOC home web page. It is within the scope of the present disclosure for the first party's IP-xMOOC system disclosed herein to block access to a second party who has accessed the IP-xMOOC home web page and drilled down through two or more selected topic tabs to the “accelerated onboarding” module and then chosen not to provide information of agree to become a registered user after the second party has accessed such content more than a number selected from “n+1” times, wherein “n” is the selected number.

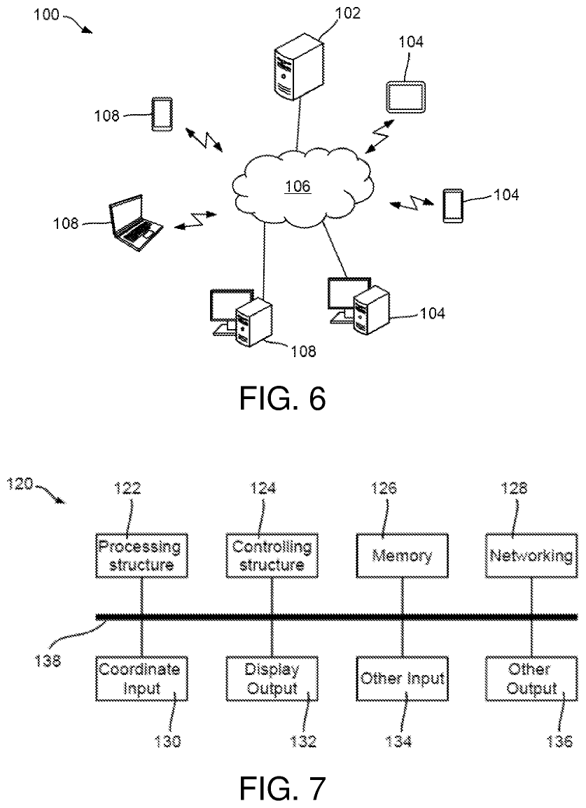

According to other embodiments of the present disclosure, an example of a first party's system for online secured two-party collaborative preparation of a formal IP application and controlled online delivery of the application to a selected agency is illustrated in FIG. 6. This example system 100 may comprise a server computer 102, one or more first party's client-computing devices 104, and one or more second parties' client-computing devices 108 functionally interconnected by a network 106, for example, such as the Internet, a local area network (LAN), a wide area network (WAN), and/or the like, via suitable wired and/or wireless networking connections.

The example system 100 may be accessed by second parties' client-computing devices 108 with suitable wired or wireless communication interfaces for functionally connecting to the server computer 102 via the network 106.

The server computer 102 executes one or more server programs. Depending on implementation, the server computer 102 may be a server computing device and/or a general-purpose computing device acting as a server computer while also being used by a user.

Each client-computing device 104, 108 executes one or more client application programs for users to use. The client-computing devices 104, 108 in these embodiments are preferably portable computing devices such as laptop computers, tablets, smartphones, Personal Digital Assistants (PDAs) and the like. However, those skilled in the art will appreciate that one or more client-computing devices 104, 108 may be non-portable computing devices such as desktop computers in some alternative embodiments.

Generally, the computing devices 102, 104, and 108 have a similar hardware structure such as a hardware structure 120 shown in FIG. 7. As shown, the computing device 102/104/108 comprises a processing structure 122, a controlling structure 124, a memory or storage 126, a networking interface 128, a coordinate input 130, a display output 132, and other input and output modules 134 and 136, all functionally interconnected by a system bus 138.

The processing structure 122 may be one or more single-core or multiple-core computing processors such as INTEL® microprocessors (INTEL is a registered trademark of Intel Corp., Santa Clara, Calif., USA), AMD® microprocessors (AMD is a registered trademark of Advanced Micro Devices Inc., Sunnyvale, Calif., USA), ARM® microprocessors (ARM is a registered trademark of Arm Ltd., Cambridge, UK) manufactured by a variety of manufactures such as Qualcomm of San Diego, Calif., USA, under the ARM® architecture, or the like.

The controlling structure 124 comprises a plurality of controllers, such as graphic controllers, input/output chipsets and the like, for coordinating operations of various hardware components and modules of the computing device 102/104/108.

The memory 126 comprises a plurality of memory units accessible by the processing structure 122 and the controlling structure 124 for reading and/or storing data, including input data and data generated by the processing structure 122 and the controlling structure 124. The memory 126 may be volatile and/or non-volatile, non-removable or removable memory such as RAM, ROM, EEPROM, solid-state memory, hard disks, CD, DVD, flash memory, or the like. In use, the memory 126 is generally divided to a plurality of portions for different use purposes. For example, a portion of the memory 126 (denoted as storage memory herein) may be used for long-term data storing, for example, storing files or databases. Another portion of the memory 126 may be used as the system memory for storing data during processing (denoted as working memory herein).

The networking interface 128 comprises one or more networking modules for connecting to other computing devices or networks through the network 106 by using suitable wired or wireless communication technologies such as Ethernet, WI-FI®, BLUETOOTH® (BLUETOOTH is a registered trademark of Bluetooth Sig Inc., Kirkland, Wash., USA), ZIGBEE® (ZIGBEE is a registered trademark of ZigBee Alliance Corp., San Ramon, Calif., USA), 3G, 4G, and 5G wireless mobile telecommunications technologies, and/or the like. In some embodiments, parallel ports, serial ports, USB connections, optical connections, or the like may also be used for connecting other computing devices or networks although they are usually considered as input/output interfaces for connecting input/output devices.

The display output 132 comprises one or more display modules for displaying images, such as monitors, LCD displays, LED displays, projectors, and the like. The display output 132 may be a physically integrated part of the computing device 102/104/108 (for example, the display of a laptop computer or tablet), or alternatively, it may be a display device physically separate from but functionally coupled to, other components of the computing device 102/104/108 (for example, the monitor of a desktop computer).

The coordinate input 130 comprises one or more input modules for one or more users to input coordinate data wherein the input modules may be touch-sensitive screens, touch-sensitive whiteboards, trackballs, computer mouse, touch-pads, or other human interface devices (HID), and the like. The coordinate input 130 may be a physically integrated part of the computing device 102/104/108 (for example, the touch-pad of a laptop computer or the touch-sensitive screen of a tablet), or it may be a display device physically separate from, but functionally coupled to, other components of the computing device 102/104/108 (for example, a computer mouse). The coordinate input 130, in some implementation, may be integrated with the display output 132 to form a touch-sensitive screen or a touch-sensitive whiteboard.

The computing device 102/104/108 may also comprise other inputs 134 such as keyboards, microphones, scanners, cameras, and the like. The computing device 102/104/108 may further comprise other outputs 136 such as speakers, printers, positioning modules for example GPS modules, and the like.

The system bus 138 interconnects various components 122 to 136 enabling them to transmit and receive data and control signals to/from each other.

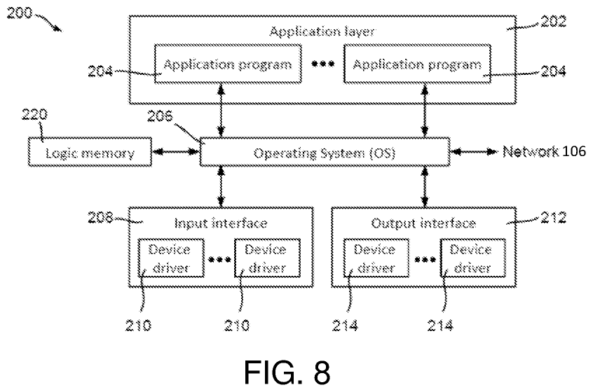

FIG. 8 shows a simplified software architecture 200 of a computing device 102/104/108. The software architecture 200 comprises an application layer 202, an operating system 206, an input interface 208, an output interface 212 and logic memory 220. The application layer 202 comprises one or more application programs 204 executed or run by the processing structure 122 for performing various jobs. The operating system 206 manages various hardware components of the computing device 102/104/108 via the input interface 208 and the output interface 212, manages logic memory 220, and manages and supports the application programs 204. The operating system 206 is also in communication with other computing devices (not shown) via the network 106 to allow application programs 204 to communicate with application programs running on other computing devices.

As those skilled in the art will appreciate, the operating system 206 may be any suitable operating system such as MICROSOFT® WINDOWS® (WINDOWS is a registered trademark of the Microsoft Corp., Redmond, Wash., USA), APPLE® OS X, APPLE® iOS (APPLE is a registered trademark of Apple Inc., Cupertino, Calif., USA), Linux, ANDROID® (ANDROID is a registered trademark of Google Inc., Mountain View, Calif., USA), or the like. The computing devices 102/104/108 of the system 100 may all have the same operating system, or may have different operating systems.

The input interface 208 comprises one or more input device drivers 210 for communicating with respective input devices including the coordinate input 150. The output interface 212 comprises one or more output device drivers 214 managed by the operating system 206 for communicating with respective output devices including the display output 152. Input data received from the input devices via the input interface 208 are sent to the application layer 202, and are processed by one or more application programs 204. The output generated by the application programs 204 is sent to respective output devices via the output interface 212.

The logical memory 220 is a logical mapping of the physical memory 146 for facilitating access by the application programs 204. In this embodiment, the logical memory 220 comprises a storage memory area that is may be mapped to a non-volatile physical memory, such as hard disks, solid state disks, flash drives, and the like, for generally long-term storage of data therein. The logical memory 220 also comprises a working memory area that is generally mapped to a high-speed, and in some implementations, volatile, physical memory, such as RAM, for application programs 204 to generally temporarily store data during program execution. For example, an application program 204 may load data from the storage memory area into the working memory area, and may store data generated during its execution into the working memory area. The application program 204 may also store some data into the storage memory area as required or in response to a user's command.

In a server computer 102 or a client-computing device when acting as a server 102, the application layer 202 generally comprises one or more server application programs 204, which provide server-side functions for managing network communication with client-computing devices 104, 108, and facilitate the operation of the system 100.

In a client-computing device 104, 108, the application layer 202 generally comprises one or more client-application programs 204 which provide client-side functions for communicating with the server application programs 204, displaying information and data on the graphic user interface (GUI) thereof, receiving user's instructions, and collaborating with the server application programs 204 for managing the system 100, and the like.

Another embodiment of the present disclosure relates to an example method for online secured collaborative preparation of a formal IP application by the first party and a second party, and for controlled secured filing by the first party, of the formal IP application with a selected agency. The example method generally comprises the steps of:
1. the second party lands on the IP-xMOOC home web page, for example, as a result of a keyword search or random scanning of IP-related websites.
2. the second party selects a topic from a list of topics provided on the home web page, and clicks on the topic tab.
3. after accessing the selected topic tab landing page that will display, for example a “digital BD funnel” (FIG. 1), the second party may then browse through the accelerator pack, the accelerator module, and the accelerator onboarding funnel. If the second party discloses the information and agrees to become a registered user, then the next landing page in this topic tab will provide access to additional elevated hierarchical lists of video content, digital interfaces, and work product templates. Non-limiting examples of suitable work product templates at this stage include “preparation for patenting” checklists, fillable “invention disclosure forms”, keyword search terms and phrases for patent database searching, among others.
   It is to be noted that a registered second party user may be allowed to print or alternatively, download a “pdf” version of their filled-in work product templates while they are accessing and using the IP-xMOOC materials online. However, any work products created by a registered second party user will not be saved in the IP-xMOOC system or in the IP-xMOOC cloud after the registered second party user logs-off the IP-xMOOC website.
4. if the second party proceeds further through the elevated hierarchical lists of video content, digital interfaces, and work product templates, the IP-xMOOC system will provide another gated module wherein the second party will be presented with an online fillable “client engagement & retainer agreement” that they will be required to complete, sign digitally, and provide a specified retainer fee by electronic funds transfer (or by credit card payment).
5. the completed and signed “client engagement & retainer agreement” will be reviewed by a designated representative of the first party, who will also verify receipt of the specified retainer fee, and then approve the “client engagement & retainer agreement”
6. after the “client engagement & retainer agreement” has been reviewed and approved by the first party's designate, the second party will then be able to access one or more selected formal IP document templates. Examples of formal IP document templates include trademark registration application templates, industrial design registration templates, patent application templates, among others.
   It should be noted that the second party may select a service provider from the first party's list of service provider at step 4 or step 5 and the selected service provider may accept or decline the second party's request. In the event that a selected service provider declines a request for engagement for a second party, the declining service provide may suggest another of the first party's service provider or alternatively, the second party may select another service provider from the list of the first party's service providers.
7. the second party will then enter their information into the selected formal work product to create a first draft of the work product, then save the first draft into a database provided therefor in the IP-xMOOC system, and forward the first draft to the selected service provider.
8. The service provider will review, provide comments, revise and add to the first draft of the work products, and then save the draft in the IP-xMOOC system as a second draft, and then forward the second draft to the second party for their review, comments, and further revisions.
9. Steps 6 and 7 will be repeated as many times as necessary for the second party and the service provider to reach agreement on the formal IP work product being in final form.
10. The second party will then provide formal approval and instructions for the service provider to file the formal IP work product electronically with a selected agency. Examples of suitable agencies include the Canadian Intellectual Property Office, the United States Patent and Trademark Office, The World Intellectual Property Office, the European Patent Office, and Patent Offices in those jurisdictions that are signatories to the Patent Cooperation Treaty, among others.
11. The service provider will then prepare and execute the requisite filing documents for filing with the formal IP product, and then proceed to file the IP product and supporting documentation and fee, with a selected agency.
12. The service provider will then report to the second party with copies of the IP documents filed and the electronic filing receipt provided by the agency.

Although embodiments have been described above with reference to the accompanying drawings, those of skill in the art will appreciate that variations and modifications may be made without departing from the scope thereof as defined by the appended claims.

1. A computer-implemented method for online secured two-party collaborative preparation of a formal intellectual property (IP) application document and controlled encrypted online filing of the document with a selected government agency, the method comprising:
providing, by a first party, controllable access to an IP-xMOOC web site and a related IP-xMOOC system configured to provide digital access to a plurality of IP-related content items organized and distributed by the first party into and within a four-level hierarchal organization of content items, wherein
the top level of the hierarchal organization contains a first portion of the plurality of IP-related content items,
the second level of the hierarchal organization contains a second portion of the plurality of IP-related content items,
the third level of the hierarchal organization contains a third portion of the plurality of IP-related content items,
the fourth level of the hierarchal organization contains a fourth portion of the plurality of IP-related content items, and
a first computer-implemented restricted-access gate is provided between the top level and the second level of the hierarchal organization;
a second computer-implemented restricted-access gate is provided between the second level and the third level of the hierarchal organization,
a third computer-implemented restricted-access gate is provided between the third level and the fourth level of the hierarchal organization;
providing a second party access to the first party's IP-xMOOC web site for entering into the top-level of hierarchal organization of content items and browsing therethrough the first portion of the plurality of IP-related content items;
providing the second party access to the second level of the hierarchal organization of content items after receiving an accepted input from the second party into the first computer-implemented restricted-access gate thereby granting the second party a first registered user access to the second portion of the plurality of IP-related content items;
providing the second party access to the third level of the hierarchal organization of content items after receiving an accepted input from the second party into the second computer-implemented restricted-access gate thereby granting the second party an enhanced registered user access to the third portion of the plurality of IP-related content items;
providing the second party access to the fourth level of the hierarchal organization of content items after receiving a series of accepted inputs from the second party into the third computer-implemented restricted-access gate thereby granting the second party an onboarded client status and access to the fourth portion of the plurality of IP-related content items;
receiving from the second party as the onboarded client a selection of an IP application document template from the fourth plurality of IP-related content items, receiving from the second party as the onboarded client information and data and entering the received information and data into the selected IP application document template thereby producing a partially completed IP document, and electronically encrypting and sending the partially completed IP document to the first party;
electronically exchanging the partially completed IP application document between the first party and the onboarded client for one or more times until the IP application document is completed;
receiving from the second party as the onboarded client after the second party has accessed such content, instructions for filing the completed IP application document with the selected government agency; and
electronically filing, by the first party, the completed IP application document with the selected government agency.

2. The computer-implemented method according to claim 1, wherein the first party is an IP service provider firm comprising one or more registered patent agents/attorneys and/or one or more registered trademark agents/attorneys.

3. The computer-implemented method according to claim 1 wherein the first portion of the plurality of IP-related content items in the top level of the hierarchal organization comprises a plurality of viewable-only content items.

4. The computer-implemented method according to claim 3, wherein the viewable-only content items pertain to one or more of patents, trademarks, copyrights, tradesecrets, industrial designs, and include recorded video contents, recorded audio contents, slide presentations, written materials in the forms of scrollable web pages, uploaded articles in pdf format, videos of panel discussions and/or interviews, webinars, podcasts, voice-over slide presentations, and a listing of the first party's one or more registered patent agents/attorneys and/or one or more registered trademark agents/attorneys.

5. The computer-implemented method according to claim 1, wherein the first portion of the plurality of IP-related content items is searchable by the second party.

6. The computer-implemented method according to claim 5, wherein the first portion of the plurality of IP-related content items is temporarily tabulated into one or more lists during a browsing event by the second party.

7. The computer-implemented method according to claim 1, wherein the first computer-implemented restricted-access gate requires the second party to input (i) a username, (ii) their email address, and optionally one or more of (iii) their IP interest(s), (iv) their vocation, (v) an employer category, and (vi) their employment position/category to thereby receive a registered user status from the first party.

8. The computer-implemented method according to claim 1, wherein the second portion of the plurality of IP-related content items in the second level of the hierarchal organization additionally comprises an expanded plurality of viewable-only content items and a plurality of downloadable content items.

9. The computer-implemented method according to claim 1, wherein the second computer-implemented restricted-access gate is a paywall that requires the second party to provide a one-time payment for access to a content item from the third portion of the plurality of IP-related content items, and/or an annual subscription payments for unrestricted access to some or all of the third portion of the plurality of IP-related content items.

10. The computer-implemented method according to claim 1, wherein the third portion of the plurality of IP-related content items additionally comprises a plurality of interactive downloadable and fillable content items.

11. The computer-implemented method according to claim 10, wherein the plurality of interactive downloadable and fillable content items includes a plurality of learning modules pertaining one or more of IP portfolio development and management, patenting basics, patent claiming strategies, global patenting strategies, branding and trademarking basics, global branding and trademarking strategies, prior art searching and IP landscaping, global IP monitoring and enforcement, IP commercialization options and strategies.

12. The computer-implemented method according to claim 11, wherein each of the plurality of learning modules comprises a curriculum of between two to 12 separate lessons with a self-monitoring and assessment guide.

13. The computer-implemented method according to claim 1, wherein the third computer-implemented restricted-access gate is a client-onboarding gate and requires:
the second party to input (i) their username, (ii) their email address, (iii) their vocation, (iv) an employer category, (v) their employment position/category, (vi) a request for one or more selected IP services from the first party;
the first party to review the second party's inputs and to make a decision to accept or decline the request for IP services from the second party;
if the first party's decision is to decline the request for IP services, then a first digital message will be sent to the second party with a notification that their request has been declined;
if the first party's decision is to accept the request for IP services, a computer-implemented engagement letter will be generated with the second party's inputs and forwarded to the second party with instructions to execute and return the engagement letter with a retainer fee specified in the engagement letter;
the second party to return an executed engagement letter and provide a payment for the specified retainer fee; and
the first party to provide a notice to the second party that they have been designated as an onboarded client and provided with unrestricted access to the fourth portion of the plurality of IP-related content items in the fourth level of the hierarchal organization.

14. The computer-implemented method according to claim 13, additionally comprising an option for the onboarded client to request an engagement with a selected one of the registered patent agents/attorneys and/or one of the registered trademark agents/attorneys.

15. The computer-implemented method according to claim 1, wherein the fourth portion of the plurality of IP-related content items comprises one or more of a downloadable and fillable patent application template, an industrial design application template, a trademark application template, and a copyright application template.

16. A computer system for online secured two-party collaborative preparation of a formal application document and controlled online delivery of the document to a selected agency, the system comprising:
a memory;
one or more cloud-based databases;
a network or a communication connection; and
a processing structure coupled to the memory, the one or more cloud-based databases, and the network or the communication connection;
wherein the processing structure, the memory, the one or more cloud-based databases, and the network or the communication connection form a single computerized platform; and
wherein the processing structure is configured for creation by a first party of an IP-xMOOC web for controllable access by a second party, for registering the second party as a registered user, an enhanced registered user, and for onboarding the second party as a client.
